(19) United States
(12) Patent Application Publication
(10) Pub. No.: US 2018/0024619 A1
(43) Pub. Date: Jan. 25, 2018

(54) DISPLAY DEVICE, DISPLAY CONTROL METHOD, AND COMPUTER-READABLE STORAGE MEDIUM

(71) Applicant: CASIO COMPUTER CO., LTD., Tokyo (JP)

(72) Inventors: Tomoo KASUO, Tokyo (JP); Eiji YAMAKAWA, Tokyo (JP)

(73) Assignee: CASIO COMPUTER CO., LTD., Tokyo (JP)

(21) Appl. No.: 15/636,003

(22) Filed: Jun. 28, 2017

(30) Foreign Application Priority Data
Jul. 21, 2016 (JP) 2016-143703

(51) Int. Cl. G06F 1/32; G09G 3/36

(52) U.S. Cl. CPC G06F 1/3296; G09G 3/3607; G06F 1/3228; G06F 1/3265; G09G 2330/021; G09G 2320/0666; G09G 2310/08

(57) ABSTRACT

Provided is a display device comprising: a display which has a normal display mode and a power saving display mode, wherein a display appearance in the power saving display mode is different from a display appearance in the normal display mode, and wherein a power consumption in the power saving display mode is less than a power consumption in the normal display mode; a sensor which detects a state of the display device; a timer which starts to measure time based on a detection result of the sensor; and a controller which switches the display mode of the display from the normal display mode to the power saving display mode in the case where the measured time of the timer is equal to or longer than predetermined transition time.

### BACKGROUND OF THE INVENTION

### 1. Field of the Invention

The present invention relates to a display device, a display control method, and a program.

### 2. Description of the Related Art

Preferably, a display device such as an electronic clock on which a liquid crystal display device is mounted is continuously driven by a built-in battery for a long period of time. Accordingly, some appliances performs power saving display to reduce power consumption by turning off the display under certain specified conditions.

For example, Japanese Patent Application Laid-Open No. 2016-092457 discloses a mobile terminal which acquires sound output from a speaker by using a microphone and then switches a power mode to a power saving mode, considering that the user does not use the mobile terminal when determining that the volume of the acquired sound is attenuated to a predetermined threshold or lower level on the basis of the sound volume of the output sound.

In a display device such as an electronic clock, power consumption thereof tends to increase according to an environment in which the display device is used. In that environment, however, limitation on the power consumption is not considered.

### SUMMARY OF THE INVENTION

The present invention has been provided to solve the above problem. Therefore, an object of the present invention is to provide a display device which reduces power consumption without compromising user-friendliness.

In order to solve the above problem, a display device according to the present invention includes: a display unit which has a normal display mode and a power saving display mode, wherein a display appearance in the power saving display mode is different from a display appearance in the normal display mode, and wherein a power consumption in the power saving display mode is less than a power consumption in the normal display mode; a sensor which detects a state of the display device; a timer which starts to measure time based on a detection result of the sensor; and a controller which switches the display mode of the display unit from the normal display mode to the power saving display mode in the case where the measured time of the timer is equal to or longer than predetermined transition time.

According to the present invention, the power consumption of the display device is able to be reduced without compromising user-friendliness.

### BRIEF DESCRIPTION OF THE SEVERAL VIEWS OF THE DRAWING

FIG. 1 is a diagram illustrating the configuration of a display device;

FIG. 2 is a diagram illustrating the display appearance of a clock display at a normal operation of a display device of an embodiment;

FIG. 3A is a diagram illustrating a display example of the display appearance of a clock display in a first power saving mode which is obtained by controlling the clock display from the normal operation mode to a power saving display mode;

FIG. 3B is a diagram illustrating a display example of the display appearance of a clock display in a second power saving mode which is obtained by further controlling the clock display from the first power saving mode to another power saving mode;

FIG. 3C is a diagram illustrating a display example of the display appearance of a clock display in a sleep mode of the display device of the embodiment;

FIG. 4A is a diagram illustrating the display appearance of a liquid crystal display in another normal display operation;

FIG. 4B is a diagram illustrating the display appearance of a liquid crystal display in another first power saving mode;

FIG. 4C is a diagram illustrating the display appearance of a liquid crystal display in another second power saving mode;

FIG. 5 is a processing flow diagram of a power saving display control of a liquid crystal display unit;

FIG. 6 is an entire processing flow diagram of the power saving display control of the liquid crystal display unit; and

FIG. 7 is a processing flow diagram of performing the power saving display control according to a temperature.

### DETAILED DESCRIPTION OF THE INVENTION

Hereinafter, an embodiment of the present invention will be described in detail with reference to attached drawings.

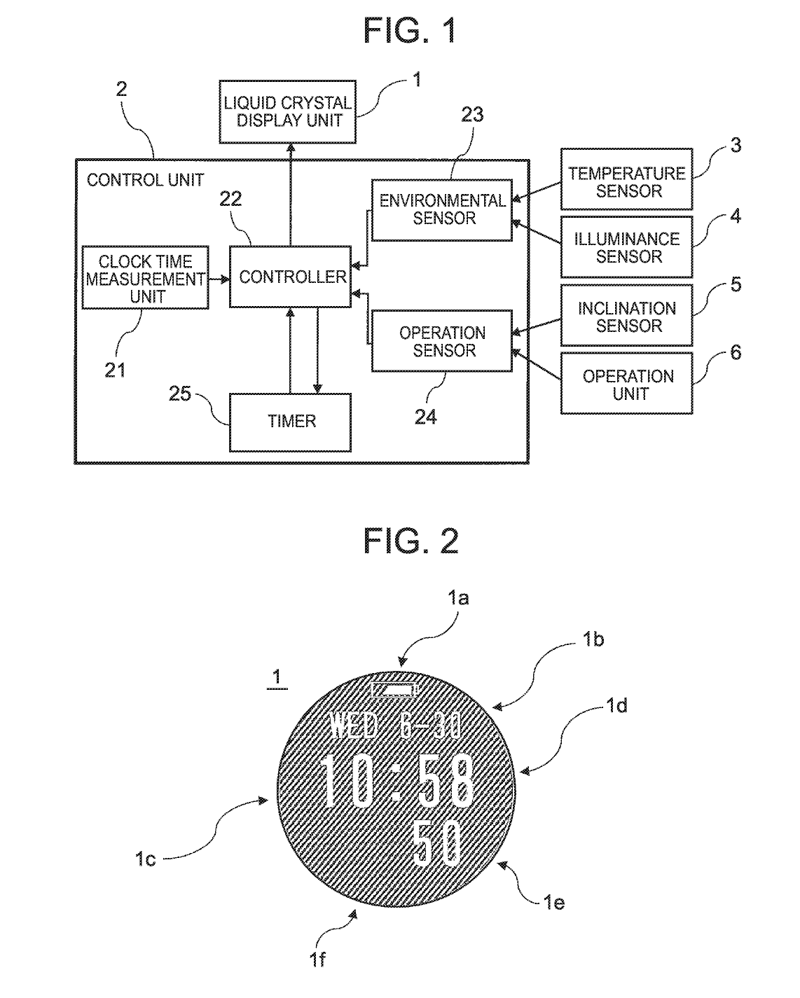

FIG. 1 is a diagram illustrating the configuration of a display device according to the embodiment.

A control unit 2 of the display device is connected to a temperature sensor 3 which detects the temperature of the display device, an illuminance sensor 4 which detects the illuminance of an installation environment of the display device, an inclination sensor 5 which detects a change (tilting or moving) of the display device, and an operation unit 6 such as an operation key which is provided in a case or the like of the display device, by which a date and time are displayed on a liquid crystal display unit 1 (a display unit) capable of performing dot matrix display.

More specifically, the control unit 2 measures the time by using a clock time measurement unit 21 which measures the year, date, hour, minute, and second of the clock and displays the time measurement information on the liquid crystal display unit 1 (a display unit) by means of a controller 22.

Moreover, the controller 22 detects an environmental state of the display device by means of an environmental sensor 23 (a sensor) to which the temperature sensor 3 and the illuminance sensor 4 are connected and detects an operating state of the display device by means of an operation sensor 24 (a sensor) to which the inclination sensor 5 and the operation unit 6 are connected.

The controller 22 monitors changes in the state information of the display device detected by the environmental sensor 23 and the operation sensor 24, which are sensors, and controls the power saving display of the liquid crystal display unit 1 on the basis of a timer 25. The details of the power saving control will be described later.

The functions of the controller 22 are implemented by a program stored in a read-only memory (ROM), which is not illustrated, executed by a microcomputer (a microprocessor), which is not illustrated.

In the case of a clock having a power-generating unit such as a solar cell instead of the aforementioned illuminance sensor 4, the controller 22 may detect the illuminance of the installation environment of the display device on the basis of an output voltage of the solar cell.

Furthermore, the controller 22 may detect the operating state of the display device by using a gyro sensor or an acceleration sensor instead of the inclination sensor 5.

The display device of this embodiment is able to perform dot matrix display and uses a reflective memory liquid crystal module which retains display image data by means of a memory embedded in the pixels for the liquid crystal display unit 1. The use of the reflective memory liquid crystal module eliminates the necessity for a backlight, and further the use of the reflective memory liquid crystal module reduces the driving power of a matrix driver of the liquid crystal module.

The following describes a display example of the display device of the embodiment.

FIG. 2 illustrates the display appearance of a clock display at a normal operation (in a normal operation mode) of the display device of the embodiment.

The display device of this embodiment displays a clock with the day of week, date, and time on the liquid crystal display unit 1. The state other than the power saving display mode and the sleep mode of the display device described later in detail is referred to as “normal operation mode.”

The liquid crystal display unit 1 is of a normally white system, for example. Considering the design of the clock display, however, the background (the part indicated by hatching) is displayed in black in the normal operation mode, while the display information (the day of week, month, and day [1b], hour [1c], minute [1d], and second [1e] of the clock, and the remaining battery level mark [1a]) is displayed in white.

In the liquid crystal module of the normally white system, the reflectance is maximized (a state in which the screen is white) when no voltage is applied to the liquid crystal, while the reflectance decreases (the screen is black) when a voltage is applied. Therefore, the liquid crystal pixels on the background part is in a state where a voltage is applied.

For example, with respect to the characters representing the second (1e) (“50” in FIG. 2), the pixel data of the characters representing the second (1e) is rewritten in one-second periods. Moreover, with respect to the character of the colon (1f) (“:” in FIG. 2), blinking display at one Hz (display in black in 0.5-second periods or display in white in 0.5-second periods) may be performed in some cases. In this case, the pixel data of the colon (1f) character is rewritten at every 0.5 second. With respect to the characters representing the minute (1d) (“58” in FIG. 2), pixel data of the characters representing the minute (1d) is rewritten in one-minute periods. With respect to the characters representing the hour (1c) (“10” in FIG. 2), the pixel data of the characters representing the hour (1c) is rewritten in 60-minute periods. With respect to other characters, pixel data is rewritten appropriately.

The more the number of liquid crystal pixels to which voltage is applied is, the more the reflective memory liquid crystal module used as the liquid crystal display unit 1 consumes electric power even in the case of the still image display.

Furthermore, if the drive of the matrix driver of the liquid crystal pixels is reduced, power consumption decreases. Specifically, power consumption is relatively low when pixel data rewriting is not performed.

Furthermore, the lower the frequency of the AC voltage drive of the liquid crystal is, the lower the power consumption is.

In view of the characteristics of the consumption of electric power of the aforementioned liquid crystal display unit 1, the display device of this embodiment performs the power saving display control described below.

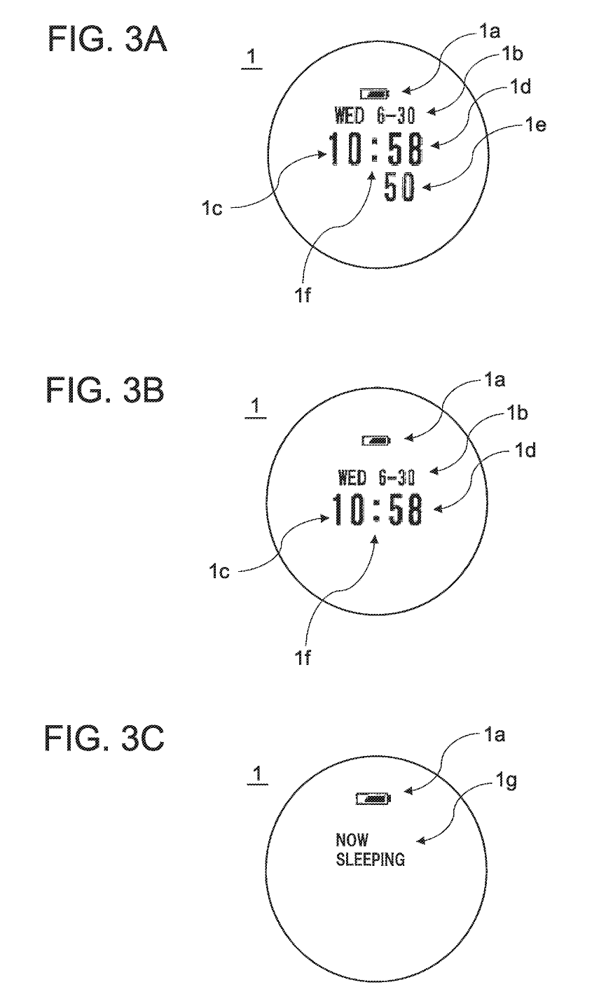

FIG. 3A illustrates a display example in a first power saving mode (a first power saving display mode) under the power saving display control, which is different in the display appearance, obtained from the clock display in the normal operation mode of FIG. 2.

More specifically, in the first power saving mode of FIG. 3A, the display in the normal operation mode in FIG. 2 is reversed on the liquid crystal display unit 1 of the normally white system in the same manner as the above so as to obtain a display with black text on white background different in the display appearance. This reduces the number of liquid crystal pixels to which a voltage is applied, thereby reducing the power consumption of the liquid crystal display unit 1.

Furthermore, as illustrated in FIG. 3A, a display different in the display appearance may be made by reducing the size of the display in the center of the display area of the liquid crystal display unit 1 without changing the display information of the day of week, month, and day (1b), hour (1c), minute (1d), and second (1e) of the clock, and the remaining battery level mark (1a).

FIG. 3B illustrates a display example in a second power saving mode (a second power saving display mode) different in the display appearance which is obtained by further performing the power saving control on the display in the first power saving mode of FIG. 3A.

The display appearance is different in such a way that the display is made with a display appearance in which the character size is further reduced in comparison with the display in the first power saving mode of FIG. 3A and that the characters of the second (1e) are not displayed since the pixel data of the characters of the second needs to be rewritten in one-second periods. Furthermore, the blinking display of the colon (1f) is not performed.

This further reduces the number of liquid crystal pixels to which a voltage is applied, thereby reducing the power consumption of the liquid crystal display unit 1 and decreasing the rewriting (the display update frequency) of the liquid crystal data, by which the power consumption decreases.

FIG. 3C illustrates a display in the sleep mode of the display device of the embodiment.

A different display appearance is provided by eliminating the clock display with only displays of the remaining battery level mark (1a) and characters “NOW SLEEPING” (1g) to indicate that the display device is placed in the sleep mode.

In this state, the clock is not displayed and therefore the periodic rewriting of liquid crystal data does not occur. Therefore, the power consumption of the matrix driver is minimized, thus achieving the minimum power consumption of the liquid crystal display unit 1.

In the above, further power saving may be made by setting the frequency of the AC voltage drive of the liquid crystal to a lower level within a range free from the influence of flicker.

As described in the above display examples of FIGS. 2, 3A, 3B, and 3C, the display of the display device of the embodiment is configured to have power saving modes of two steps such as a first power saving mode (FIG. 3A) different in the display appearance and a second power saving mode (FIG. 3B) further different in the display appearance between the normal operation mode (FIG. 2) and the sleep mode (FIG. 3C). The display of the display device, however, may be configured to have more power saving modes.

For example, as the first power saving mode, it is also possible to add a stage in which the colors of the background and characters are reversed without changing others or to add a stage of the power saving display mode in which the display of the character representing the colon (1f), which has been blinking in the power saving mode in FIG. 3A, is not blinking or to add a stage of changing the character size.

In the display device of the embodiment, a clock is displayed in both power saving modes. Therefore, a user of the display device is able to visually recognize or read the time in the same manner as in the normal operation mode and thus the user-friendliness is not compromised in the power saving modes.

The above description has been made by giving an example that the reflective memory liquid crystal module used as the liquid crystal display unit 1 is a liquid crystal display of the normally white system. On the other hand, in the case of a normally black system, the background is displayed in white in the normal operation mode and the display information (the day of week, month, and day [1b], hour [1c], minute [1d], second [1e], and colon [1f] of the clock, and the remaining battery level mark [1a]) is displayed in black.

Then, in the first power saving mode, the display is white-black reversed so as to achieve a display with white text on black background and the character size on the display is reduced.

In the second power saving mode, the character size is further reduced and the characters of the second (1e) and colon (1f), which require the rewriting of the pixel data in one-second periods, are not displayed.

In the sleep mode, the clock is not displayed and the remaining battery level mark (1a) and characters “NOW SLEEPING” (1g) are displayed in white to indicate that the display device is placed in the sleep mode.

In the case where a color reflective memory liquid crystal module is used as the liquid crystal display unit 1, the color pixels used in the power saving mode may be limited. For example, in the first power saving mode, the display is made with liquid crystal pixels of any two (for example, R and G colors) of the RGB three colors. In the second power saving mode, the display is made with liquid crystal pixels of any one (for example, B color) of the RGB three colors.

This reduces the number of liquid crystal pixels to which a voltage is applied, thus reducing the power consumption of the liquid crystal display unit 1.

Generalizing the description of the power saving display control of the display device of the above embodiment, the power saving display control is performed by combination with the processing of decreasing the number of liquid crystal pixels to which a voltage is applied by performing color reverse, the processing of decreasing the number of liquid crystal pixels to which a voltage is applied by reducing the size of characters displayed by applying a voltage to the liquid crystal pixels, the processing of eliminating the display of characters whose liquid crystal data is rewritten in short periods, the processing of changing the configuration of character strings to a configuration which does not cause rewriting of periodic liquid crystal data, or the processing of limiting the color pixels to be used, so that a plurality of power saving display modes is provided in the liquid crystal display unit 1.

The following describes a method of driving another liquid crystal display unit 1.

As described above, the liquid crystal display unit 1 of the display device according to the embodiment is controlled in the power saving display so as to increase the number of liquid crystal pixels to which a voltage is not applied.

Thereby, in the liquid crystal display unit 1, the memory element provided in each pixel is set in a state where a voltage is not applied thereto. In other words, the memory elements are powered in such a way as to keep the state where a voltage is not applied to the liquid crystal pixels.

In addition, although not driven, the matrix driver related to liquid crystals to which a voltage is not applied is powered, too.

In this manner, a circuit related to liquid crystals to which a voltage is not applied also consumes power.

Therefore, in another liquid crystal display unit 1 of the display device of the embodiment, the liquid crystal display unit 1 is divided into a plurality of segments to perform multiplexing drive in which liquid crystal drive is performed for a predetermined segment while remaining segments are not powered in a power saving mode.

For example, the matrix driver, the memory elements of the liquid crystal pixels, and the common electrode of the liquid crystals are divided so as to achieve multiplexing drive with three segments in the liquid crystal display unit 1.

In addition, power is supplied to all of the three segments in performing liquid crystal drive in the normal display operation.

In the first power saving mode, liquid crystal drive is performed for any two of the three segments and power is not supplied to the remaining one segment.

In the second power saving mode, liquid crystal drive is performed for any one of the three segments and power is not supplied to the remaining two segments.

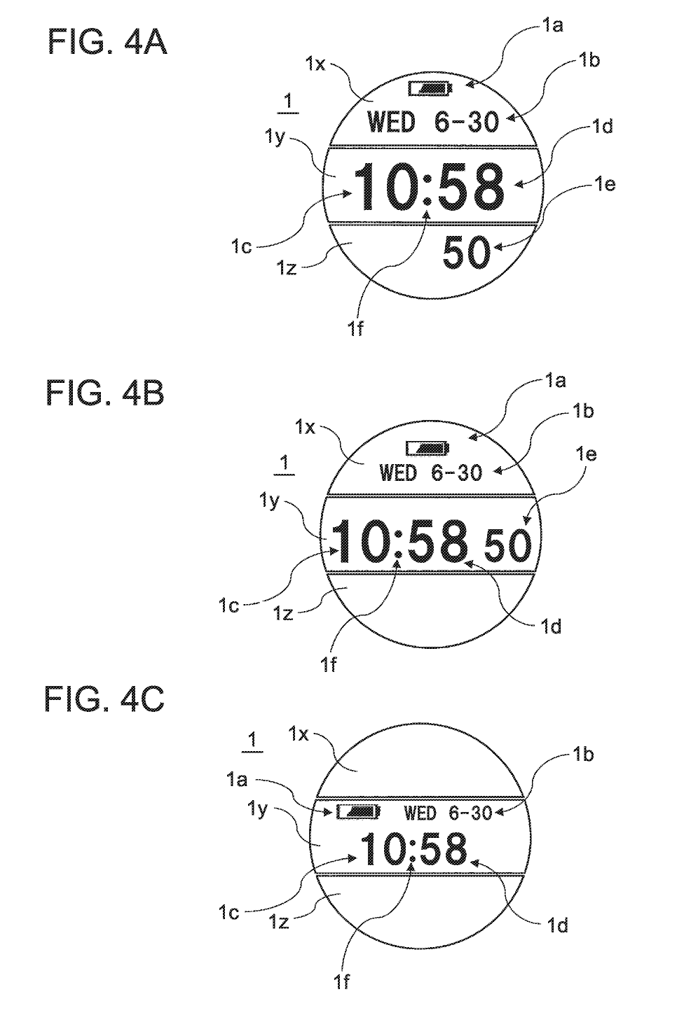

Subsequently, other display examples of the display device of the embodiment will be described with reference to FIGS. 4A, 4B, and 4C.

The display device of this embodiment is described by giving an example of dividing the display surface of the liquid crystal display unit 1 into three segments in a vertical direction (a direction perpendicular to a paper surface). Note that each horizontal line in the diagram is illustrated to represent the segment division and actually not displayed.

FIG. 4A illustrates a liquid crystal display in the normal display operation. The remaining battery level mark (1a) and the day of week, month, and day (1b) of the clock are displayed in the top segment 1x, the hour (1c), minute (1d), and colon (1f) of the clock are displayed in the middle segment 1y, and the second (1e) of the clock is displayed in the bottom segment.

FIG. 4B illustrates a liquid crystal display of the first power saving mode. The remaining battery level mark (1a) and the day of week, month, and day (1b) of the clock are displayed in the top segment 1x, the hour (1c), minute (1d), second (1e), and colon (1f) of the clock are displayed in the middle segment 1y. Power is not supplied to the bottom segment 1z and therefore no data is displayed in the bottom segment 1z.

In this state, power saving display control is performed by reducing the size of characters displayed in the top segment 1x and in the middle segment 1y.

FIG. 4C illustrates a liquid crystal display in the second power saving mode. The remaining battery level mark (1a) and the hour (1c), minute (1d), second (1e), and colon (1f) of the clock are displayed in the middle segment 1y, while power is not supplied to the top segment 1x and the bottom segment 1z and therefore no data is displayed in these segments.

In this state, power saving display control is performed by further reducing the size of characters displayed in the middle segment 1y so as to be smaller than in the first power saving mode.

Although not illustrated, the remaining battery level mark (1a) and characters “NOW SLEEPING” (1g) are displayed in the middle segment like in FIG. 4C, when the display device of this embodiment is placed in the sleep mode.

With the use of the liquid crystal display unit 1 of the normally white system, the clock display described with reference to FIG. 2 may be used in the normal display operation while performing the power saving display control in which the display is white-black reversed like in FIG. 4A in the first power saving mode.

In this case, the power saving display control as in FIG. 4B is performed in the second power saving mode and the power saving display control as in FIG. 4C is performed in the third power saving mode.

The following describes the power saving display control which is performed by the controller 22 (see FIG. 1).

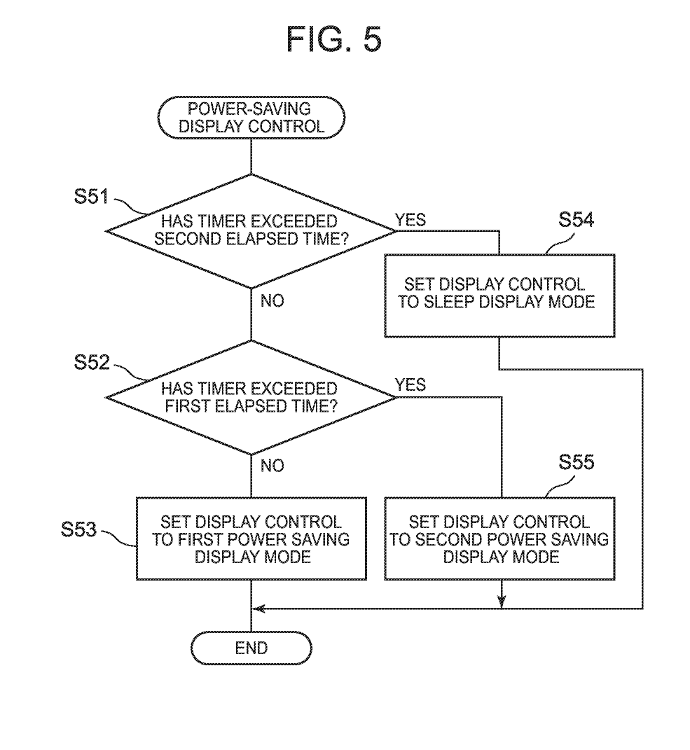

FIG. 5 illustrates a processing flow of a power saving display control in which the controller 22 switches the liquid crystal display unit 1 between the first power saving mode, the second power saving mode, and the sleep mode described with reference to FIGS. 3A, 3B, and 3C.

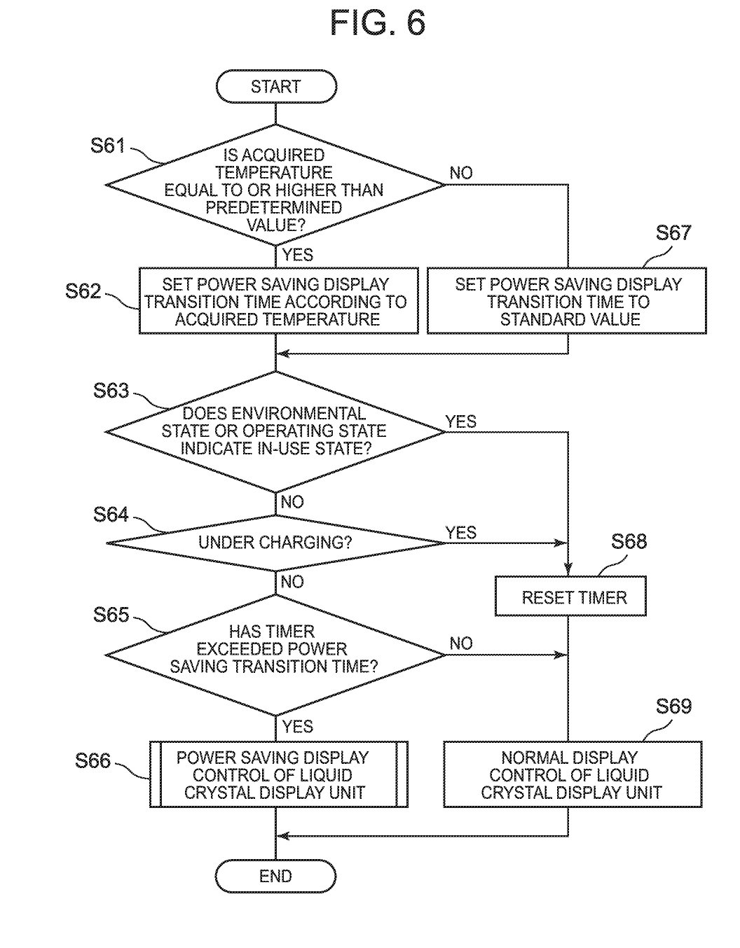

Note that the processing flow of FIG. 5 is regarded as one module of processing of FIG. 6 described later.

The controller 22 determines whether or not a predetermined second elapsed time has passed with reference to the time measured by the timer 25 (see FIG. 1) (S51). The second elapsed time is a determination time for a transition to the sleep mode and is previously stored in the control unit 2.

If the timer does not exceed the second elapsed time in step S51 (No in S51), the control proceeds to step S52.

In step S52, the controller 22 determines whether or not a predetermined first elapsed time (transition time) has passed with reference to the time of the timer measured by the timer 25 (S52). The first elapsed time is a determination time for a transition to the second power saving mode and is previously stored in the control unit 2.

Unless the timer exceeds the first elapsed time in step S52 (No in S52), the controller 22 sets the display control of the liquid crystal display unit 1 to the first power saving display mode to perform the power saving display control described with reference to FIG. 3A (S53) and ends the processing.

If the timer exceeds the first elapsed time in step S52 (Yes in S52), the controller 22 sets the display control of the liquid crystal display unit 1 to the second power saving display mode to perform the power saving display control with reference to FIG. 3B (S55) and ends the processing.

If the timer exceeds the second elapsed time in step S51 (Yes in S51), the controller 22 sets the display control of the liquid crystal display unit 1 to the sleep mode to perform the power saving display control described with reference to FIG. 3C (S54) and ends the processing.

According to the aforementioned processing flow, the display control is switched sequentially in stepwise manner between the plurality of power saving display modes, the first power saving display mode (FIG. 3A), the second power saving display mode (FIG. 3B), and the sleep display state (FIG. 3C), depending on the time measured by the timer 25.

FIG. 6 illustrates the entire processing flow of the power saving display control performed by the controller 22 (See FIG. 1).

With respect to the liquid crystal display unit 1 of the display device of the embodiment, the higher the temperature is, the more the power is consumed due to a leak current (leakage current) or the like. Therefore, the time period for a transition to the power saving display mode is reduced according to the temperature in performing the power saving display control of the liquid crystal display unit 1. This reduces the power consumption in a high-temperature environment.

The following describes an operation of the display device of the embodiment illustrated in FIG. 1.

The processing flow of FIG. 6 is performed in constant periods. In step S61, the controller 22 acquires an environmental temperature with the temperature sensor 3 connected to the environmental sensor 23 and determines whether or not the acquired temperature is equal to or higher than a predetermined value.

Unless the acquired temperature is equal to or higher than the predetermined value (No in S61), the power saving transition time for a transition of the liquid crystal display unit 1 to the power saving display mode is set to a standard value (S67). Then, the control proceeds to step S63.

If the acquired temperature is equal to or higher than the predetermined value in step S61 (Yes in S61), the controller 22 sets the power saving transition time (transition time) according to the acquired temperature (environmental temperature) (S62). The correspondence between the environmental temperature and the power saving transition time is previously registered. This correspondence is freely settable. Thereafter, the control proceeds to step S63.

In step S63, the controller 22 acquires the environmental state by the temperature sensor 3 and the illuminance sensor 4 connected to the environmental sensor 23 and acquires the operating state by the inclination sensor 5 and the operation unit 6 connected to the operation sensor 24. The controller 22 then determines whether or not the acquired environmental state or operating state indicates that the display device of the embodiment is in use.

For example, if the display direction of the display device indicated by the inclination sensor 5 is within a predetermined angle corresponding to the user's viewing direction, the display device is determined to be in use.

Moreover, if the operation unit 6 is being operated, the display device is determined to be in use.

Furthermore, if the temperature sensor 3 or the illuminance sensor 4 provides a detected value within a predetermined range, the display device is determined to be in use.

Unless the environmental state or the operating state indicates that the display device is in use (No in S63), it is determined whether or not the display device of the embodiment is being charged by a power-generating unit such as a solar cell (S64). This is because, if the display device is being charged, the display device can be driven by the power-generating capacity of the solar cell and therefore a decrease in the remaining battery does not occur, by which it is unnecessary to place the liquid crystal display unit 1 in the power saving display mode.

Unless the display device is being charged in step S64 (No in S64), the control proceeds to step S65.

In step S65, the controller 22 determines whether the count value of the free-running timer exceeds the power saving transition time with reference to the timer 25. Specifically, the controller 22 determines whether the time during which the display device is not used has passed beyond the power saving transition time.

If the timer exceeds the power saving transition time in step S65 (Yes in S65), the controller 22 performs the processing flow of the power saving display control described with reference to FIG. 5 (S66).

Thereby, the liquid crystal display unit 1 transitions to the power saving display mode and the power saving display mode of the liquid crystal display unit 1 is switched according to an elapsed time, thereby enabling a reduction in the power consumption.

If the environmental state or the operating state of the display device indicates that the display device is in use (Yes in S63) or if the display device is being charged (Yes in S64), the counter of the timer 25 is reset and the timer for the determination of the elapsed time is reset (S68).

The controller 22 then sets the liquid crystal display unit 1 to the normal display control state (S69). Thereby, if the liquid crystal display unit 1 has been controlled in the power saving display, the liquid crystal display unit 1 is returned to the normal display mode.

Unless the timer exceeds the power saving transition time in step S65 (No in S65), the controller 22 places the liquid crystal display unit 1 in the normal display control state (S69). In addition, if the timer exceeds the power saving transition time in step S65 (Yes in S65), the controller 22 controls the liquid crystal display unit 1 in the power saving display (S66). Specifically, the controller 22 performs the processing of the flow in FIG. 5 described in the above.

The controller 22 performs the above processing in predetermined periods, thereby reducing the power consumption of the display device by changing the power saving display mode in a stepwise manner with the display pattern changed without changing the display contents when the time measured by the timer 25 exceeds the predetermined power saving transition time.

While the setting of the power saving display mode has been changed according to the elapsed time in the power saving display control of the liquid crystal display unit 1 illustrated in FIG. 5, a description will be made below on a case of changing the setting of the power saving display mode by using another parameter other than the elapsed time.

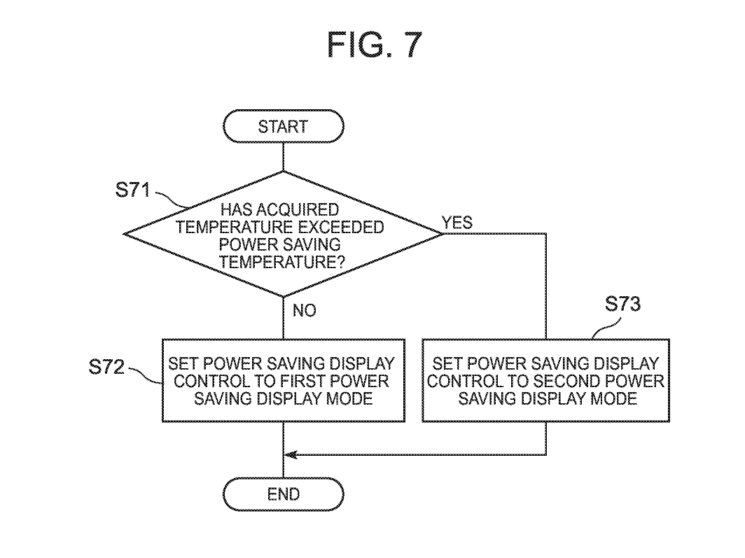

With respect to the liquid crystal display unit 1 of the display device of the embodiment, the higher the temperature is, the more the power is consumed due to a leak current (leakage current) or the like. Therefore, the power saving display control is performed on the liquid crystal display unit 1 according to the temperature as illustrated in FIG. 7, thereby reducing the power consumption in a high-temperature environment.

More specifically, the controller 22 acquires the environmental temperature by using the temperature sensor 3 connected to the environmental sensor 23 and determines whether or not the acquired temperature exceeds the power saving temperature (S71). This power saving temperature is a temperature for determining the setting to the first power saving display mode or the second power saving display mode and is previously stored in the control unit 2.

Unless the acquired temperature exceeds the power saving temperature (No in S71), the controller 22 sets the display control of the liquid crystal display unit 1 to the first power saving display mode to perform the power saving display control described with reference to FIG. 3A (S72) and ends the processing.

If the acquired temperature exceeds the power saving temperature (Yes in S71), the controller 22 sets the display control of the liquid crystal display unit 1 to the second power saving display mode to perform the power saving display control described with reference to FIG. 3B (S73) and ends the processing.

If the processing flow of FIG. 7 is performed in step S66 of the entire processing flow of the power saving display control described with reference to FIG. 6, a transition to the power saving display mode occurs in a short time period when the acquired temperature is high and the power saving display mode of the liquid crystal display unit 1 is selected according to the acquired temperature.

Although FIG. 7 illustrates an example of performing two power saving display controls for the liquid crystal display unit 1 by providing a threshold value of the power saving temperature, the present invention is not limited thereto, and three or more power saving display controls may be performed.

Furthermore, a predetermined power saving display control may be performed without providing the threshold value of the power saving temperature.

As described hereinabove, the present invention extends the battery life or protects the display device from deterioration by placing the display in the power saving mode according to a temperature environment or an appliance usage state or in a state other than a certain period of time, so as not to cause a trouble for a user against a remarkable reduction in the battery life of the appliance caused by an increase in current consumption due to a high temperature in the display device having a large ratio of the power consumption of the appliance.

While the above display device of this embodiment has been described by giving an example that a memory-in-pixel (MIP) liquid crystal is applied to the liquid crystal display unit 1, the liquid crystal display unit 1 is not limited to the display unit with the memory-in-pixel (MIP) liquid crystals as long as the power consumption of the display unit changes depending on the display pattern.

For example, in the case of a self-luminous display such as an electroluminescence (EL) display or the like, the consumption of the electric power can be reduced in a stepwise manner by changing a luminous display pattern such as the character size without changing the display content such as the clock display.

Furthermore, in the case of a liquid crystal display such as an STN liquid crystal display, the matrix driver consumes a high percentage of electric power and therefore a change in the character size or other display pattern has only a small effect of reducing the consumption of electric power. Therefore, it is preferable to perform the power saving display control by performing a division into segments as illustrated in FIGS. 4A, 4B, and 4C and decreasing the number of driven matrix drivers in a stepwise manner.

Moreover, although the display device of this embodiment has been described by giving an example of performing a clock display while saving power in a stepwise manner, the display content is not limited to the clock display and the present invention is applicable to a case in which other contents are displayed. The present invention is applicable to a watch having a mobile terminal function or an information terminal with a built-in battery such as a glasses-type information terminal or other wearable terminals.

What is claimed is:

1. A display device comprising:
a display which has a normal display mode and a power saving display mode,
wherein a display appearance in the power saving display mode is different from a display appearance in the normal display mode, and
wherein a power consumption in the power saving display mode is less than a power consumption in the normal display mode;
a sensor which detects a state of the display device;
a timer which starts to measure time based on a detection result of the sensor; and
a controller which switches the display mode of the display from the normal display mode to the power saving display mode in the case where the measured time of the timer is equal to or longer than predetermined transition time.

2. The display device according to claim 1, wherein the display information in the normal display mode is maintained and power consumption is less than in the normal display mode in the power saving display mode.

3. The display device according to claim 1, wherein an update frequency for changing the display information is lower than in the normal display mode in the power saving display mode.

4. The display device according to claim 1, wherein:
the controller displays the display information by the display appearance represented by white text on a black background on the display in the normal display mode; and
the controller displays the display information by the display appearance represented by reversing the display information to black text on a white background on the display in the power saving display mode.

5. The display device according to claim 1, wherein:
the controller displays the display information by the display appearance represented by white text on a black background on the display in the normal display mode; and
the controller displays the display information by the display appearance from which information whose update frequency is high is deleted out of the display information and which is represented by reversing the display information to black text on a white background on the display in the power saving display mode.

6. The display device according to claim 1, wherein the controller displays the display information after switching the display of the display to a power saving display mode in which a display area smaller than a display area of the normal display mode is driven.

7. The display device according to claim 1, wherein the controller displays the display information after switching the display to a power saving display mode in which the display is made by using a smaller number of colors than a plurality of colors constituting the pixels used in the normal display mode.

8. The display device according to claim 1, wherein:
the sensor detects a device temperature of the display device; and
the controller sets the transition time based on the device temperature in the case where the device temperature is equal to or higher than a predetermined temperature.

9. The display device according to claim 1, wherein the controller does not perform the switching to the power saving display mode in the case where the sensor detects a charging operation.

10. A display control method for a display device including a display part which displays display information, the method comprising the steps of:
detecting a state of the display device;
starting to measure the time of a timer based on the detection result of the step; and
switching the display of the display part from a normal display mode to a power saving display mode in which the display appearance differs from that in the normal display mode and power consumption is less than in the normal display mode in the case where the measured time of the timer is equal to or longer than predetermined transition time.

11. The display control method according to claim 10, wherein the display information in the normal display mode is maintained and power consumption is less than in the normal display mode in the power saving display mode.

12. The display control method according to claim 10, wherein an update frequency for changing the display information is lower than in the normal display mode in the power saving display mode.

13. A computer-readable storage medium which stores a program including a series of instructions which a display device, having a display part which displays display information, causes an incorporated computer to perform, the program comprising the steps of:
detecting a state of the display device;
starting to measure the time of a timer based on the detection result; and
switching the display of the display part from a normal display mode to a power saving display mode in which the display appearance differs from that in the normal display mode and power consumption is less than in the normal display mode in the case where the measured time of the timer is equal to or longer than predetermined transition time.

14. The computer-readable storage medium according to claim 13, wherein the display information in the normal display mode is maintained and power consumption is less than in the normal display mode in the power saving display mode.

15. The computer-readable storage medium according to claim 13, wherein an update frequency for changing the display information is lower than in the normal display mode in the power saving display mode.
